(19) United States
(12) Patent Application Publication
(10) Pub. No.: US 2024/0376358 A1
(43) Pub. Date: Nov. 14, 2024

(54) WATER-SLIP MEMBRANE AND ARTICLE HAVING WATER-SLIP MEMBRANE ON SURFACE

(71) Applicant: MURAKAMI CORPORATION, Shizuoka (JP)

(72) Inventors: Masatoshi NAKAMURA, Shizuoka (JP); Mao AJIOKA, Shizuoka (JP); Kyu-Hong KYUNG, Tokyo (JP); Yoshio HOTTA, Tokyo (JP); Seimei SHIRATORI, Chiba (JP)

(73) Assignee: MURAKAMI CORPORATION, Shizuoka (JP)

(21) Appl. No.: 18/579,980

(22) PCT Filed: Jul. 15, 2022
(86) PCT No.: PCT/JP2022/027922

§ 371 Date: Jan. 17, 2024

(30) Foreign Application Priority Data
Jul. 27, 2021 (JP) 2021-122645

(51) Int. Cl. C09K 3/18

(52) U.S. Cl. CPC C09K 3/18

(57) ABSTRACT

A water-sliding membrane includes a base layer formed on a glass substrate and a lubricating layer retained to the base layer. The base layer is formed by modifying a reactive functional-group to a surface of the substrate, the lubricating layer is configured of a polymer including a reactive functional-group that can form a covalent bond with the reactive functional-group of the base layer, and a portion of the reactive functional-group of the base layer and a portion of the reactive functional-group of the lubricating layer form the covalent bond. Moreover, the base layer includes a cyclic conjugated functional-group modified to the surface of the substrate, the lubricating layer includes a polymer having a hydrogen atom charged to δ⁺, and a portion of the cyclic conjugated functional-group of the base layer and a portion of the hydrogen atom charged to δ⁺ of the lubricating layer have π-electron interaction.

### RELATED APPLICATION

This application claims the priority of Japanese Patent Application No. 2021-122645 filed on Jul. 27, 2021, the disclosure of which is incorporated herein by reference in its entirety.

### TECHNICAL FIELD

The present invention relates to a water-sliding membrane composed of a base layer and a lubricating layer retained to the base layer, and an article having a surface coated with the same.

### BACKGROUND ART

To achieve a non-wetting property (roll-off property) for liquid, there is an idea of forming a membrane of a lubricating liquid on a surface of an article. In conventional techniques, it was necessary to form a microporous structure on the surface of the article in advance and make the lubricating liquid retained to the microporous structure in order to prevent leakage of the lubricating liquid.

On the other hand, the liquid-sliding membrane of Patent literature 1 is characterized in that the base layer retains the lubricating liquid by π-electron interaction. Therefore, it is attracting attention in the point that it is not necessary to form the microporous structure on the surface of the article and a sliding property can be imparted to a flat surface.

Moreover, in recent years, cameras and lenses are miniaturized by the development of image processing techniques, and a property of adhesion of water droplets in an image capture port of a small area is becoming more important. Conventionally, the adhesion property of water droplets has been mainly evaluated by visual observation, and water droplets or liquid droplets of 10 μl or greater which can be easily formed by a dropper have been used upon evaluation. However, it is known that minuter liquid droplets have a greater effect on visibility. It is because when liquid droplets are smaller, adhesion force increases by a minute recess or dirt on the surface.

In Patent literature 1, the roll-off property is evaluated with a water droplet of 10 μl or greater, and an evaluation related to a liquid droplet smaller than 10 μl is not carried out. Moreover, it is reported in Patent literature 1 that, in a superhydrophobic surface (SHS), movement of a liquid droplet of 5 μl is inhibited due to unevenness of the surface, making it difficult for the liquid droplet to slide down. Accordingly, the inventors established a method of forming a surface of which a liquid droplet of 4 μl or smaller (diameter φ=2 mm or smaller) can slide down.

### CITATION LIST

### Patent Literature

Patent Literature 1: Japanese Patent No. 6678018 B

### SUMMARY OF INVENTION

### Technical Problem

While the inventors were advancing for implementation of the liquid-sliding membrane disclosed in Patent literature 1, the liquid-sliding membrane of Patent literature 1 had a problem that it cannot maintain the roll-off property of a water droplet having a diameter of 1 to 2.5 mm (the water droplet does not roll off) after 120 hours of a weathering test or 240 hours of a salt-spray resistance test.

The object of the present invention is to provide a water-sliding membrane that is composed of a base layer formed on a substrate and a lubricating layer retained to the base layer, and maintains a roll-off property of above a certain level after a weathering test or a salt-spray resistance test.

### Solution to Problem

The inventors diligently studied to solve the above-described problem. As a result, they found that by having a layer of which a reactive functional group is modified to a surface of the substrate as a base layer and forming a lubricating layer with a polymer having a reactive functional group that forms a covalent bond with the reactive functional group above, a portion of the reactive functional group of the base layer and a portion of the reactive functional group of the lubricating layer form the covalent bond, and a roll-off property above a certain level can be maintained after a weathering test or a salt spray resistance test, and completed the present invention.

That is, a water-sliding membrane according to the present invention comprises:
a base layer formed on a substrate and a lubricating layer retained to the base layer, wherein
the base layer is formed by modifying a reactive functional group to a surface of the substrate,
the lubricating layer is configured of a polymer comprising a reactive functional group that can form a covalent bond with the reactive functional group of the base layer,
a portion of the reactive functional group of the base layer and a portion of the reactive functional group of the lubricating layer form the covalent bond,
the base layer comprises a cyclic conjugated functional group modified to the surface of the substrate,
the lubricating layer comprises a polymer comprising a hydrogen atom charged to δ⁺, and
a portion of the cyclic conjugated functional group of the base layer and a portion of the hydrogen atom charged to δ⁺ of the lubricating layer have π-electron interaction.

Here, the “reactive functional group” is preferably at least one type of a functional group selected from a group consisting of a carbon-carbon double bond containing group, a carboxy group, an amino group, a hydroxy group, and an epoxy group. Moreover, the term “form a covalent bond” includes a polymerization reaction, a copolymerization reaction, a crosslink structure and a graft structure. Moreover, the “cyclic conjugated functional group” indicates one in which a conjugated double bond forms a ring like a benzene ring, in particular, among functional groups having a conjugated double bond in which two or more double bonds are connected with single bonds interposed therebetween.

In the present invention, the base layer is preferably a silicon oxide (SiOx) comprising the reactive functional group and the cyclic conjugated functional group.

In the present invention, the lubricating layer is preferably a modified silicone comprising the reactive functional group and the hydrogen atom charged to δ⁺.

In the present invention, the reactive functional group of the base layer is preferably at least one type of a functional group selected from a group consisting of a vinyl group, an acrylic group, a methacrylic group, a carboxy group, an amino group, a hydroxy group, and an epoxy group, and the cyclic conjugated functional group of the base layer is preferably a phenyl group.

In the present invention, the reactive functional group of the lubricating layer is preferably at least one type of a functional group selected from a group consisting of a carboxy group, a vinyl group, an acrylic group, a methacrylic group, an amino group, a hydroxy group and an epoxy group, and the hydrogen atom charged to δ⁺ is preferably a portion of at least one type of a functional group selected from a group consisting of a carboxy group, a phenol group and a hydroxy group.

In the present invention, a mass ratio of a component of the cyclic conjugated functional group of the base layer and a component of the reactive functional group of the base layer is preferably 1:1 to 1:3.

An article according to the present invention has a surface coated with the water-sliding membrane.

The water-sliding membrane and the article according to the present invention exhibit the following actions and effects.
(1) The roll-off property after a weathering test or a salt spray resistance test dramatically improves by suitably imparting, to the base layer and the lubricating layer, the covalent-bonding component that is formed by the reactive functional group and the component that exhibits π-electron interaction, respectively.
(2) In particular, durability performance (of roll-off property) dramatically improves in a salt spray resistance test compared to a case in which covalent bonding and π-electron interaction are used alone, without using them in combination. Such effect greatly exceeds an effect that is expected when the two (covalent bonding and π-electron interaction) are simply used in combination, and it can be said that it is an unexpected effect.
(3) A weathering test is a test of repeating water spraying and drying while performing UV irradiation. Since covalent bonding has stronger bonding compared to π-electron interaction, it has an effect of improving weatherability by strengthening covalent bonding between the base layer and the lubricating layer. However, deterioration of the roll-off property after a salt spray resistance test could not be improved only by covalent bonding. The reason is considered to be that, in the salt spray resistance test, force of the base layer retaining the lubricating layer is weakened by salt water having a high osmotic pressure gradually immersing to an interface between the base layer and the lubricating layer. On the other hand, when π-electron interaction is used, it is considered that the lubricating layer coats the base layer precisely, so that immersion of salt water to the interface between the base layer and the lubricating layer is suppressed and durability to the salt spray resistance test becomes relatively good. However, since bonding itself of π-electron interaction is weak, it is significantly weak in a weathering test in which water spraying and drying are repeated.

In the present invention, the two (covalent bonding and π-electron interaction) are suitably used in combination, so that both of strong bonding between the base layer and the lubricating layer and preciseness of coating by the lubricating layer can be achieved, and it is considered that an improvement effect that could not have been achieved by using it alone was achieved.

### Advantageous Effects of Invention

According to the present invention, in addition to π-electron interaction of the cyclic conjugated functional group of the base layer and the hydrogen atom charged to δ⁺ of the lubricating layer, since the base layer is formed by modifying the reactive functional group to the surface of the substrate and the lubricating layer is formed by the polymer comprising the reactive functional group that forms a covalent bond with the reactive functional group above, a portion of the reactive functional group of the base layer and a portion of the reactive functional group of the lubricating layer form the covalent bond, and the roll-off property above a certain level by the water-sliding property of the polymer of the lubricating layer retained to the base layer can be maintained after the weathering test or the salt spray resistance test.

### BRIEF DESCRIPTION OF DRAWINGS

FIG. 1 illustrates a schematic configuration of a water-sliding membrane according to one embodiment of the present invention.

FIG. 2 is a diagram to describe a method for producing the water-sliding membrane.

FIG. 3 illustrates an explanatory diagram of a method for evaluating a roll-off property.

FIG. 4 illustrates a graph showing a test result of a water-sliding membrane of Configuration 4 (comparative example).

FIG. 5 illustrates a graph showing a test result of a water-sliding membrane of Configuration 5 (comparative example).

FIG. 6 illustrates a graph showing a test result of a water-sliding membrane of Configuration 1 (example).

FIG. 7 illustrates a graph showing a test result of a water-sliding membrane of Configuration 2 (example).

FIG. 8 illustrates a graph showing a test result of a water-sliding membrane of Configuration 3 (example).

FIG. 9 illustrates a graph showing a test result of a water-sliding membrane of Configuration 6 (comparative example).

FIG. 10 illustrates a graph showing a test result of a water-sliding membrane of Configuration 7 (comparative example).

FIG. 11 illustrates graphs showing test results of water-sliding membranes of Configuration 1-1 (example) and Configuration 1-2 (example)

### DESCRIPTION OF EMBODIMENTS

### <Water-Sliding Membrane>

FIG. 1 illustrates a schematic configuration of a water-sliding membrane according to one embodiment of the present invention. In FIG. 1, a water-sliding membrane 10 is composed of a base layer 14 having a carbon-carbon double bond containing group (vinyl group) and a cyclic conjugated functional group (phenyl group) modified to a surface of a glass substrate 12, and a lubricating layer 16 retained to this base layer 14. The lubricating layer 16 is composed of a hydrophobic modified silicone oil modified with a reactive functional group (carboxy group) that can form a covalent bond with the vinyl group of the base layer 14, and a hydrophobic modified silicone oil modified with a functional group (phenol group) having a hydrogen atom charged to δ⁺ that can have π-electron interaction with the phenyl group of the base layer 14.

A water droplet on the water-sliding membrane 10 slides down by slightly tilting the glass substrate 12 by hydrophobicity and water-sliding property of the modified silicone oil of which a portion thereof is retained to the vinyl group of the base layer 14 by covalent bonding and the modified silicone oil of which a portion thereof is retained to the phenyl group of the base layer 14 by π-electron interaction.

### <Base Layer>

The base layer 14 of the present embodiment preferably comprises, together with the vinyl group and the phenyl group, a fixing group (e.g., a silane group) that strongly bonds with the surface of the glass substrate 12. An acrylic group or a methacrylic group can be used as the vinyl group. As the silane group, alkoxysilane such as tetraethoxysilane (TEOS) that strongly bonds by covalent bonding with the surface of the glass substrate 12 or a hydrolysis product thereof is preferably used.

As for the substrate, a good adhesion can be achieved upon hydrolysis of the base layer 14 if it has a polar group such as a hydroxy group on a surface of a glass or a metal. Therefore, it is not limited to the glass substrate 12. When it is a resin substrate, a plasma processing may be performed to form a polar group on the surface.

The base layer 14 may comprise a π-electron functional group having a high concentration of π electrons such as a phenyl group (a functional group having a benzene ring) or an alkynyl group (a functional group having a triple bond between carbon atoms). As a substance that forms the base layer 14, for example, alkoxysilane comprising a phenyl group is preferred. Examples thereof include phenyltriethoxysilane (PTES), phenyltrimethoxysilane, phenylchlorosilane, and phenylmethylchlorosilane. In order to increase the concentration of π electrons of the π-electron functional group, it is particularly preferred that a silica structure (SiO₂), an insulating portion, keeps movement of the π electron within the phenyl group like “phenyl group”-“insulating portion” (such as Ph-SiO₂). Moreover, in order to strengthen fixation to the glass substrate 12, alkoxysilane such as tetraethoxysilane (TEOS) may be mixed. By forming the base layer 14 with these substances, the phenyl group becomes modified to the surface of the glass substrate 12 via the silica structure (SiO₂).

Examples of other substances that can form the base layer 14 comprising the π-electron functional group include: aromatic alcohols such as polystyrene, phenethyl alcohol, phenol, phenanthrenol, and cresoltetrahydro-phenanthrenol:aromatic aldehydes such as phenylacetaldehyde, methoxybenzaldehyde, cuminaldehyde, and hexyl cinnamaldehyde:aromatic carboxylic acids such as phenanthrene carboxyaldehyde, phthalic acid, and benzoic acid:aromatic isocyanates; aromatic thiols such as thiophenol: phenyl chlorides; and anilines.

Moreover, as for the base layer 14 comprising (i) the vinyl group (acrylic group, methacrylic group) and (ii) the phenyl group, for example, a mixture of (i) vinyltrimethoxysilane (3-(acryloyloxy) propyltrimethoxysilane, 3-(methacryloyloxy) propyltrimethoxysilane), and (ii) alkoxysilane in which one of alkoxides such as phenyltriethoxysilane is substituted with a vinyl group (acryloxy group, methacryloxy group) or a phenyl group is hydrolyzed to form a membrane on the substrate, so that the base layer 14 comprising the vinyl group (acrylic acid, methacrylic acid) and the phenyl group can be formed.

In order to form the base layer 14 with the above-described substances, first, the surface of the glass substrate 12 where the base layer 14 is formed is preferably imparted with a solvent affinity to substances composing the base layer 14. Even when the solvent affinity is poor, a membrane can be formed by utilizing an alkaline treatment or a UV/O; treatment. A cast method, a squeegee method, a dip method, or a spin coating method can be used to the surface of the glass substrate 12.

Moreover, an organic solvent is preferably used when the base layer 14 is to be washed after formation. Examples of the organic solvent for washing include: toluene, benzene, pentane, hexane, heptane, cyclohexane, methyl chloride, methyl bromide, ethyl acetate, diethyl ether, tetrahydrofuran, ethylcellosolve, acetone, methyl ethyl ketone, methyl isobutyl ketone, methanol, ethanol, n-propanol, isopropanol, n-butanol, isobutanol, t-butanol, and chloroform.

### <Lubricating Layer>

The modified silicone oil that configures the lubricating layer 16 of the present embodiment is formed by mixing each modified silicone oil, applying the mixture onto the base layer 14, and performing heat treatment (300° C. or lower). The thickness of the lubricating layer 16 may be adjusted by application conditions, or can be adjusted by diluting with a solvent such as methyl ethyl ketone, toluene, and a mixture thereof.

As the modified silicone oil, for example, a carboxy modified silicone or a phenol modified silicone is used like FIG. 1. Such modified silicones (manufactured by Shin-Etsu Chemical Co., Ltd.) hardly volatilize at normal temperature and have a silicone main chain portion that shows lyophobicity to a target liquid to be slid, and those of which both or either terminal(s) of the silicone main chain portion or a side portion of the silicone main chain portion is/are modified with a functional group (a carboxy group, a phenol group, a vinyl group, an acrylic group, a methacrylic group, an amino group, a hydroxy group, an epoxy group, etc.) according to respective modification types are used. It can be set to a viscosity that shows a desired fluidity by adjusting the length of the silicone main chain portion. A preferred modified silicone oil is one that is within a viscosity range of 4 to 2000 cps.

The modified silicone oil may be one that is represented by the following general formula (1).

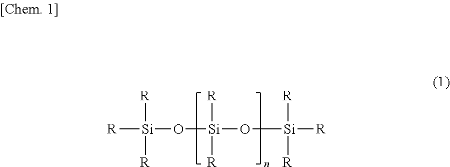

(In the formula, a portion of R is a carboxy group (—COOH) or a phenol (C₆H₅—OH), for example, and the rest of R is a methyl group (—CH₃).) For example, it may be a modified silicone oil represented by the following general formula (2),

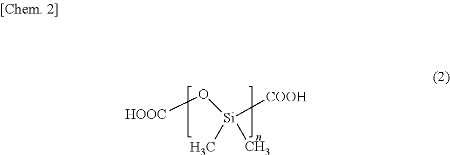

the modified silicone oil having carboxy groups at both terminals, or a modified silicone oil represented by the following general formula (3),

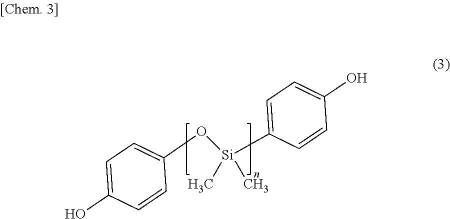

the modified silicone oil having phenols at both terminals.

Moreover, the modified silicone oil has a reactive functional group (e.g., a carboxy group, a vinyl group, an acrylic group, a methacrylic group, an amino group, a hydroxy group, an epoxy group, etc.) on at least either terminal or a side chain of the silicone main chain portion (e.g., dimethylpolysiloxane). These reactive functional groups can form a covalent bond with other modified silicones nearby, and can form a crosslink structure or a graft structure of the silicone main chain portion 22, for example.

Moreover, instead of the above-described vinyl group (acrylic group, methacrylic group), the base layer 14 may comprise the following functional groups that exhibit reactivity. These reactive functional groups can form a crosslink structure or a graft structure by covalent bonding (e.g., polymerization reaction, copolymerization reaction) with other reactive functional groups, and examples thereof include a carboxy group, an amino group, a hydroxy group, and an epoxy group. As such substance that forms the base layer 14, alkoxysilane comprising a reactive functional group is preferred. Moreover, alkoxysilane such as tetraethoxysilane (TEOS) may be mixed to strengthen fixation to the surface of the glass substrate 12. By forming the base layer 14 with these substances, the reactive functional group becomes modified to the surface of the glass substrate 12 via the silica structure (SiO₂). On a portion of the surface of the base layer 14, a portion in which a hydroxy group (—OH) is bonded to silicon (Si) is formed by hydrolysis of TEOS, and this portion may act as the reactive functional group.

The modified silicone immediately after a silicone oil is applied to the base layer 14 is liquid: however, reaction of the reactive functional group proceeds moderately like the change from left to right in FIG. 1. The reactive functional group may particularly comprise an unreacted double bond. A portion of the modified silicone of the lubricating layer 16 forms a covalent bond with the reactive functional group of the base layer 14, so that a three-dimensional network structure of the modified silicone is partially formed in the lubricating layer 16. In other words, the modified silicone oil of the lubricating layer 16 is retained to the surface of the base layer 14 while the modified silicone oil is chemically adsorbed to the base layer by covalent bonding with the reactive functional group of the base layer 14. Moreover, in the lubricating layer 16, it is considered that a three-dimensional network structure is formed by a crosslink structure or a graft structure (of covalent-bonding state between modified silicones). Moreover, when the reactive functional group of the modified silicone is an acrylic group or a methacrylic group, it may be considered that polymerization reaction of the reactive functional group with an alkyl group of the silicone main chain portion occurs by a thermal reaction.

On the other hand, the lubricating layer 16 does not form a three-dimensional network structure completely. A portion of the modified silicone still has a one-dimensional or two-dimensional structure, and the silicone main chain portion (called as a sliding-action portion herein) contributes to the sliding property of the water-sliding membrane 10. The modified silicone oil may partially remain as liquid. In a case of a modified silicone of which both terminals are reactive functional groups, crosslink reaction to the modified silicone nearby is relatively strong: therefore, a modified silicone of which one terminal is a reactive functional group is suitably mixed thereto, so that formation of the three-dimensional network structure of the lubricating layer 16 does not become excessive.

As described, a covalent bond is partially formed in the lubricating layer 16, which was liquid, and interaction between polymers is strengthened inside the lubricating layer 16. These actions become three-dimensional obstacles, and the state of which the lubricating layer 16 is retained to the base layer 14 can be maintained more easily; therefore, durability of the water-sliding membrane improves.

In the water-sliding membrane 10, a reactive functional group (e.g., a vinyl group) is modified to the surface of the base layer 14, so that a portion of the modified silicone of the lubricating layer 16 forms a covalently bond with the reactive functional group of the base layer 14, and a three-dimensional network structure (a crosslink structure or a graft structure) of the modified silicone formed in the lubricating layer 16 is strongly retained by the base layer 14.

Therefore, a portion of the three-dimensional network structure of the modified silicone is directly and strongly retained to the base layer 14, so that the modified silicone having a one-dimensional or two-dimensional structure of the lubricating layer 16 becomes retained to the base layer 14 more strongly.

As in FIG. 1, the lubricating layer 16 comprises a modified silicone having a π-electron interaction group (e.g., a phenol group) on at least either terminal, and a π-electron functional group (e.g., a phenyl group) is modified to the surface of the base layer 14.

The π-electron interaction portion (e.g., a phenol group) of the modified silicone has π-electron interaction between the π-electron functional group (e.g., phenyl group) of the base layer 14. For example, since a hydrogen (H) atom of an OH group that configures the phenol group is bonded to an oxygen (O) atom having a larger electronegativity, the hydrogen (H) atom easily bears a δ⁺ electric charge compared to the H atom bonded to the C atom having a closer electronegativity, and exhibits a strong interaction with the π electron of the π-electron functional group. By this π-electron interaction, the lubricating layer 16 coats the surface of the base layer 14 directly and precisely. Other than the phenol group, examples of the functional groups of the modified silicone that exhibits π-electron interaction includes a carboxy group, or a hydroxy group.

As described, a portion of the modified silicone is bonded by π-electron interaction between the base layer 14; however, this bonding is weaker than covalent bonding, and fluidity of the modified silicone of the main agent is secured.

In the water-sliding membrane 10 of the present embodiment, hydrophobicity and the sliding property of the silicone main chain portion allow a target liquid to be slid on the water-sliding membrane 10 to slide down by a slight inclination of the surface of the glass substrate 12. A stable sliding performance of the modified silicone can make mayonnaise, soy sauce, carbonara sauce, ketchup, coffee, honey, and curry sauce other than water droplets to slide down without remaining on the surface. Furthermore, hot water, salt water, mud water, ice and blood slide down similarly. Moreover, to a substrate having a curved surface, for example, the water-sliding membrane 10 along its surface is satisfactorily maintained by the combination of the base layer 14 and the lubricating layer 16 of the present embodiment.

### <Production Method>

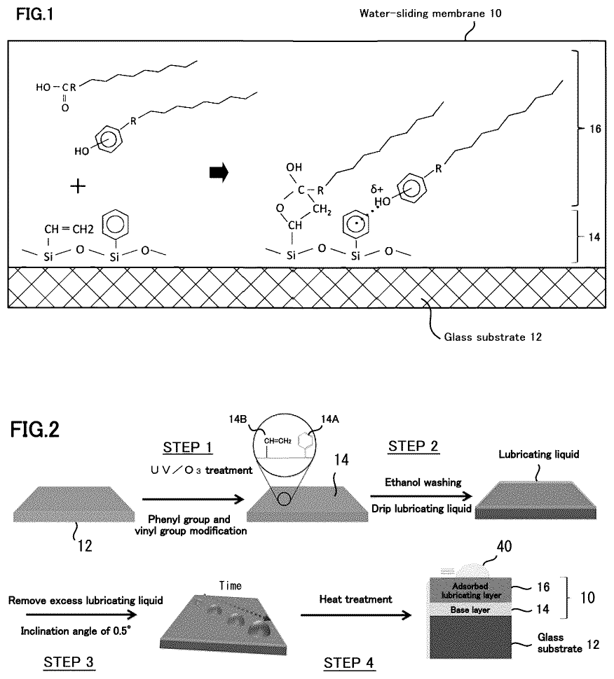

FIG. 2 shows steps for producing of the water-sliding membrane 10. A shown in Step 1, a functional group (OH group) is formed on a surface of an article (glass, metal, etc.), on the glass substrate 12 herein, by performing a UV/O₃ treatment or a strong alkaline solution treatment. Moreover, a base layer solution is prepared by adding H₂O and HClaq for hydrolysis and stirring to a stirred mixture of PTES, VTMS (vinyltrimethoxysilane), TEOS, and ethanol (EtOH). This base layer solution is applied to the surface of the glass substrate 12 by spin coating, or a dip method, a squeegee method, or a cast method, and dried. Hydrolysis reaction occurs accordingly, and the base layer 14 is formed and fixed to the surface of the glass substrate 12. Since a phenyl group and a vinyl group are not involved in hydrolysis reaction, a phenyl group 14A and a vinyl group 14B are modified on the base layer 14 like a pendant.

The base layer 14 is formed on the surface of the glass substrate 12 accordingly. It is preferred that the glass substrate 12 has a polar group such as an OH group on its surface because bonding with the base layer 14 increases. Moreover, when the article is a resin, a polar group may be formed on the surface by performing a plasma treatment.

In Step 2, the base layer 14 is washed with ethanol to remove remaining substances, such as unreacted PTES, that are not fixed to the surface of the article, and the modified silicone oil as a lubricating liquid is applied on the base layer 14 by dripping.

For example, the modified silicone oil is one in which a carboxy modified silicone and a phenol modified silicone are mixed and stirred at a specific ratio. Moreover, these modified silicones may be diluted with an organic solvent.

In Step 3, the surface of the glass substrate 12 is inclined at an inclination angle of 0.5 degrees, for example, and the excessive modified silicone oil is removed by making it to roll off. This is because the excessive lubricating layer 16 is formed upon application of the modified silicone oil. The thickness of the lubricating layer 16 can also be adjusted by changing a coating condition. Moreover, upon diluting the modified silicone oil with methylethylketone, toluene and a mixture thereof as a solvent, the thickness of the lubricating layer 16 can be also adjusted by changing the concentration of dilution. Finally, in Step 4, a heat treatment is performed such that the surface temperature becomes 300° C. or lower to make the lubricating layer 16 retained to the base layer 14. Accordingly, the water-sliding membrane 10 having a thickness of about 0.5 to 2 μm is formed on the glass substrate 12, and a target liquid to be slid (water droplet) 40 dripped on the surface of the lubricating layer 16 slides down by a slight inclination of the surface of the glass substrate 12.

In the present embodiment, since π-electron interaction occurs between the phenyl group comprised in the base layer 14 of the surface of the glass substrate 12 and the phenol group of the phenol modified silicone of the lubricating layer 16 and covalent bonding occurs between the vinyl group comprised in the base layer 14 and the carboxy group of the carboxy modified silicone in the lubricating layer 16, the lubricating layer 16 becomes bonded to the base layer 14; therefore, the lubricating layer 16 becomes difficult to be removed by an easy wiping.

In the carboxy modified silicone of the lubricating layer 16, an organic group (carboxy group) having a strong reactivity is introduced to its terminal, so that a portion of the organic group forms a covalent bond with the vinyl group of the base layer 14 by a heat treatment. Such covalent bonding strengthens interaction between molecules inside the water-sliding membrane 10, improving weatherability. Moreover, when salt water is sprayed to the waler-sliding membrane 10, since the base layer 14 is precisely coated with the lubricating layer 16 by π-electron interaction between the lubricating layer 16 and the base layer 14, immersion of salt water to the interface between the two layers is suppressed, and the sliding property does not deteriorate easily. That is, maintenance of a satisfactory sliding property and improvement in durability of the water-sliding membrane can be achieved.

Moreover, in the water-sliding membrane 10 according to the present embodiment, it is not necessary to form uneven structures on the surface of the glass substrate 12. Rather, it becomes more flattened by formation of the base layer 14 and the lubricating layer 16, so that scattering loss by the glass substrate 12 does not occur easily. As a result, a stable transmittivity can be achieved, and improvement in optical properties can be expected.

### EXAMPLE

Water-sliding membranes (Configurations 1 to 3) configured with three combinations of the base layer and the lubricating layer of Table 1 are described.

TABLE 1

| | Configuration 1 | Configuration 2 | Configuration 3 |
|---|---|---|---|
| Base layer | PTES:VTMS:TEOS = | PTES:VTMS:TEOS = | PTES:VTMS:TEOS = |
| | 0.5:0.5:2 | 0.5:0.5:2 | 0.5:0.5:2 |
| Lubricating | Carboxy modified | Methacrylic modified | Carboxy modified |
| layer | silicone + phenol | silicone + carboxy | silicone |
| | modified silicone | modified silicone | |
| | (1:1) | (1:1) | |

PTES: Phenyltriethoxysilane,
TEOS: Tetraethoxysilane,
VTMS: Vinyltrimethoxysilane

### <Salt Spray Resistance Test and Weathering Test>

Water-sliding membranes shown in Configurations 1 to 3 of Table 1 were prepared on a glass plate. Methylethylketone was used as the solvent. For example, the base layers of Configurations 1 to 3 have a common mass ratio of phenyltriethoxysilane (PTES), vinyltrimethoxysilane (VTMS) and tetraethoxysilane (TEOS) which is 0.5:0.5:2. In the lubricating layer of Configuration 1, the mass ratio of the carboxy modified silicone and the phenol modified silicone was 1:1. In Configuration 2, the mass ratio of the methacrylic modified silicone and carboxy modified silicone was 1:1. In the lubricating layer of Configuration 3, only carboxy modified silicone was used. Bonding treatment between the base layer and the lubricating layer was carried out in a heating furnace at 300° C. for 10 to 20 minutes. The final coating amount of the water-sliding membrane was within a range of 0.05 to 0.20 mg/cm², and the thickness was within a range of 0.5 to 2.0 μm.

In the salt spray resistance test (based on JIS Z 2371:2015 “Methods of salt spray testing”), salt spraying was performed to the water-sliding membranes of Configurations 1 to 3 within a range of 120 hours to 480 hours, and then the roll-off properties of each water-sliding membrane were evaluated.

Moreover, in the weathering test (based on JIS D 0205 “Test Method of Weatherability for Automotive Parts”), a weathering test was performed to the water-sliding membranes of Configurations 1 to 3 within a range of 240 hours to 620 hours, and then the roll-off properties of each water-sliding membrane were evaluated.

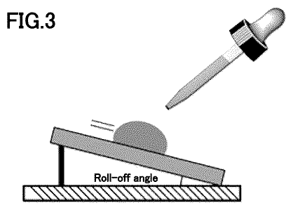

As shown in FIG. 3, the roll-off property was evaluated by dripping water on the water-sliding membrane, inclining the glass plate, and measuring an angle (roll-off angle) at which the water droplet starts to roll off. The diameter of the water droplet was arranged in 7 sizes within a range of 1 mm to 2.7 mm, and the roll-off property was evaluated based on the result of the roll-off angle of a water droplet having a diameter of 2 mm.

Configurations 4 to 5 for comparison are shown. Differences from Configurations 1 to 3 are: in Configuration 4, the base layer was formed with PTES and TEOS (mass ratio of 1:2), and VTMS was not comprised in the base layer; and the lubricating layer of Configuration 4 was formed with dimethylsilicone only, i.e., non-modified silicone only. Moreover, the base layer of Configuration 5 was formed with PTES and TEOS (mass ratio of 1:2) like Configuration 4, and the lubricating layer of Configuration 5 was prepared with phenol modified silicone, acrylic modified silicone and methacrylic silicone at a mass ratio of 20:2:2.

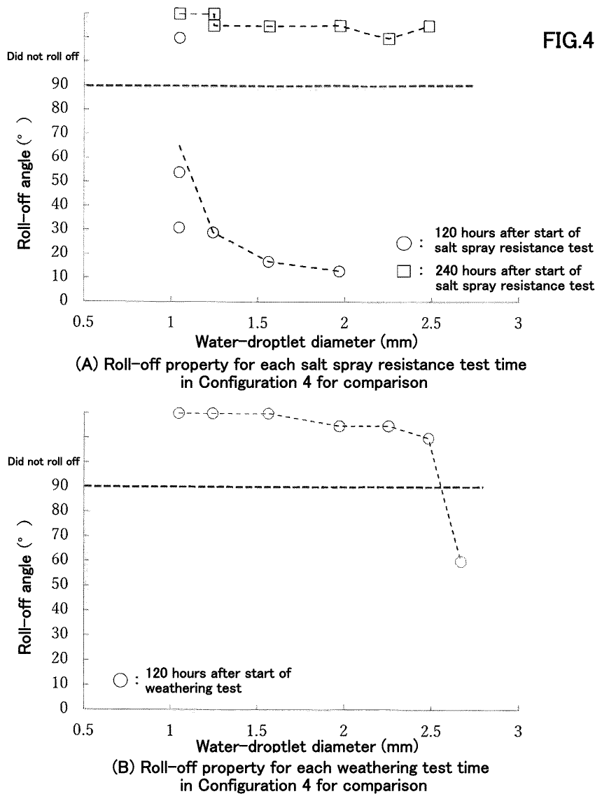

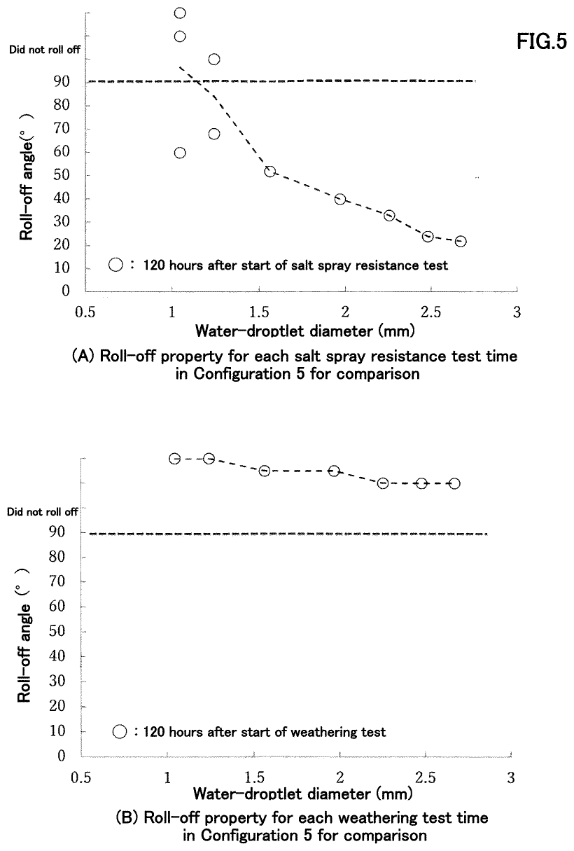

First, measurement results of the salt spray resistance test and the weathering test of Configuration 4 for comparison are shown in FIGS. 4 (A) and (B). In Configuration 4, the roll-off property was not maintained after 240 hours of the salt spray resistance test as shown in FIG. 4 (A). Moreover, the roll-off property was not maintained after 120 hours of the weathering test as shown in FIG. 4 (B). When the solvent resistance of Configuration 4 was evaluated, a water droplet having a diameter of 2 mm did not roll off after one minute of immersion in acetone.

Measurement results of the salt spray resistance test and the weathering test of Configuration 5 for comparison are shown in FIGS. 5 (A) and (B). In Configuration 5, the roll-off property was not maintained after 120 hours of the weathering test as shown in FIG. 5 (B). With respect to the salt spray resistance test (FIG. 5 (A)), the test up to 120 hours was carried out, but subsequent tests were not carried out. However, from the result of the weathering test, it is unlikely that the roll-off property over a long term can be maintained. With respect to the solvent resistance of Configuration 5, the roll-off angle of a water droplet having a diameter of 1.6 mm was 40 degrees after one minute of immersion in acetone, and was satisfactory.

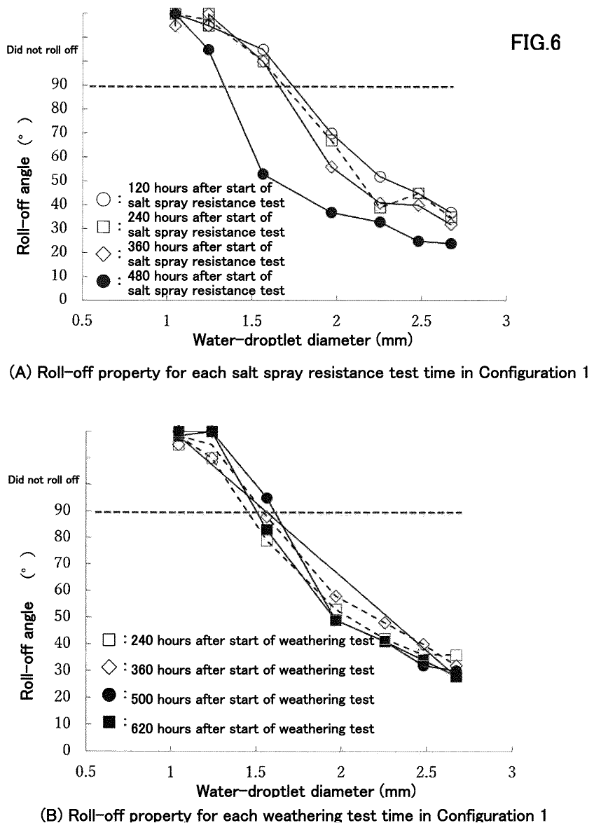

FIGS. 6 (A) and (B) show measurement results of the salt spray resistance test and the weathering test of Configuration 1 according to the Example. Configuration 1 exhibited satisfactory roll-off property after 480 hours of the salt spray resistance test and after 620 hours of the weathering test. With respect to the solvent resistance of Configuration 1, the roll-off angle of a water droplet having a diameter of 1.6 mm was 60 degrees after one minute of immersion in acetone, and was satisfactory.

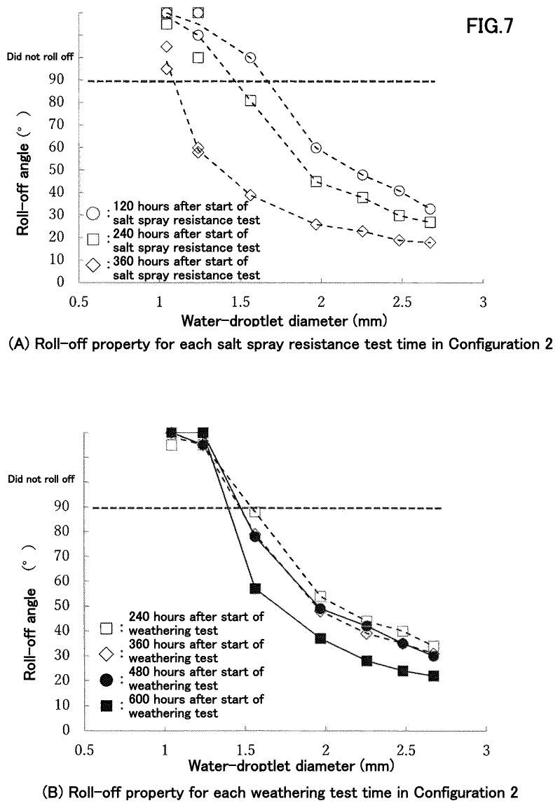

FIGS. 7 (A) and (B) show measurement results of the salt spray resistance test and the weathering test of Configuration 2 according to the Example. Configuration 2 exhibited a satisfactory roll-off property after 360 hours of the salt spray resistance test and after 600 hours of the weathering test.

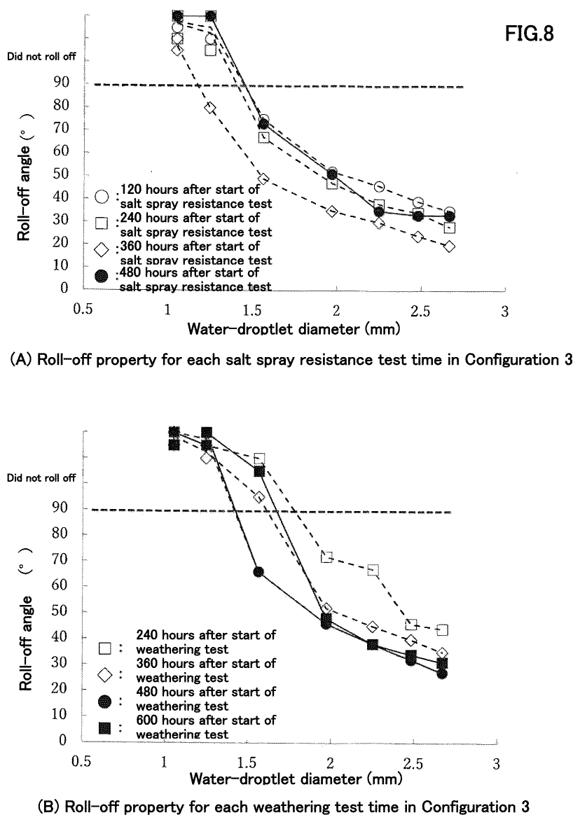

FIGS. 8 (A) and (B) show measurement results of the salt spray resistance test and the weathering test of Configuration 3 according to the Example. Configuration 3 exhibited a satisfactory roll-off property after 480 hours of the salt spray resistance test and after 600 hours of the weathering test.

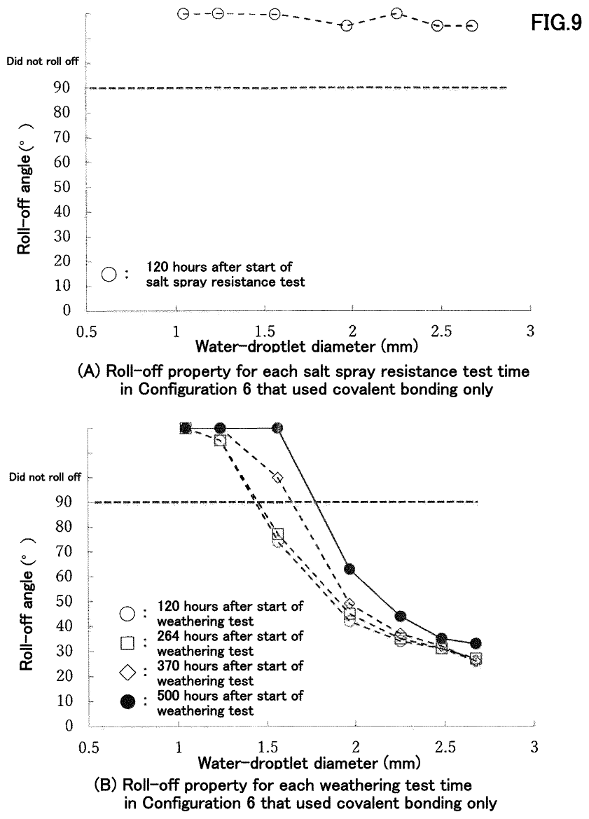

Next, in order to describe the effects of the Examples, a comparison test using Configuration 6 (base layer: VTMS:TEOS=1:2; lubricating layer: carboxy modified silicone only) that is configured of covalent bonding only was carried out. FIGS. 9 (A) and (B) show measurement results of the salt spray resistance test and the weathering test of Configuration 6 for comparison. In Configuration 6 that is configured of covalent bonding only, the roll-off property after 500 hours of the weathering test was satisfactory as shown in FIG. 9 (B); however, the roll-off property could not be maintained after 120 hours of the salt spray resistance test as shown in FIG. 9 (A).

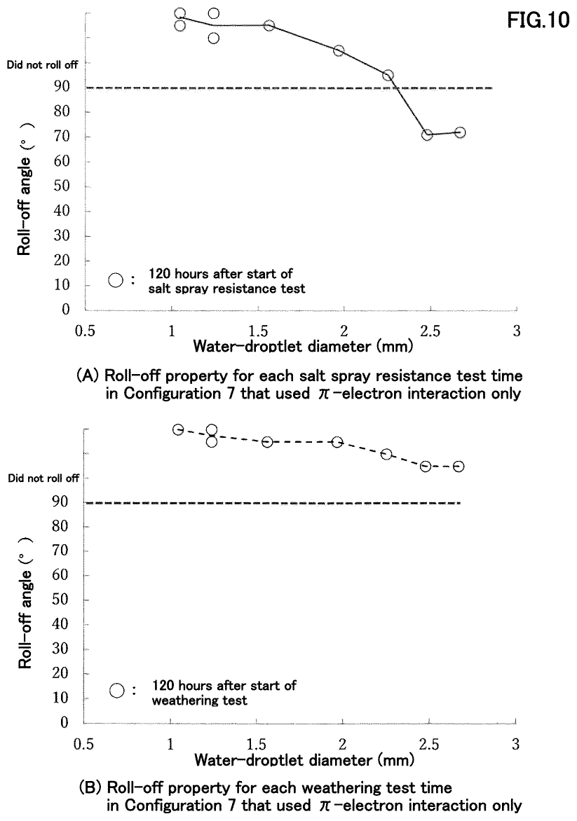

Moreover, a comparison test using Configuration 7 (base layer: PTES:TEOS=1:2; lubricating layer:phenol modified silicone) that is configured of π-electron interaction only was carried out. FIGS. 10 (A) and (B) show measurement results of the salt spray resistance test and the weathering test of Configuration 7 for comparison. In Configuration 7 that is configured of π-electron interaction only, the roll-off property could not be maintained at least after 120 hours of the salt spray resistance test and the weathering test.

Therefore, based on the test results of the Examples of FIG. 6 to FIG. 8 and the comparison results of FIG. 4, FIG. 5, FIG. 9, and FIG. 10, it can be comprehensively evaluated that an effect that cannot be easily predicted by a simple combination of covalent bonding and π-electron interaction can be achieved in the samples (Configurations 1 to 3) of the Examples.

Next, a water-sliding membrane (Configuration 1-1) similar to Configuration 1, and a water-sliding membrane (Configuration 1-2) in which component proportion of each silane of the base layer is varied were prepared to evaluate the roll-off property after the weathering test. Each configuration is shown in Table 2. In the base layer of Configuration 1-1, the mass ratio of PTES, VTMS and TEOS was 0.5:0.5:2. In the base layer of Configuration 1-2, the mass ratio of the same was 0.25:0.75:2. That is, the mass ratio of the component of the phenyl group (cyclic conjugated functional group) comprised in the base layer and the component of the vinyl group (reactive functional group) was 1:1 in Configuration 1-1, and 1:3 in Configuration 1-2.

TABLE 2

| | Configuration 1-1 | Configuration 1-2 |
|---|---|---|
| Base layer | A:C:B = 0.5:0.5:2 | A:C:B = 0.25:0.75:2 |

| | |
|---|---|
| Lubricating layer | Dual-end type phenol modified silicone + |
| | Dual-end type carboxyl modified silicone |

| | | |
|---|---|---|
| Dilution rate | MEK 7.5%, | MEK 7.5%, |
| | 22.5% dilution | 22.5% dilution |

A: PTES,
C: VTMS,
B: TEOS

The modified silicone used in the lubricating layer is manufactured by Shin-Etsu Chemical Co., Ltd. In Configurations 1-1 and 1-2, the dual-end type phenol modified silicone and the dual-end type carboxy modified silicone were used at a mass ratio of 1:1. Configurations 1-1 and 1-2 were diluted with methylethylketone (7.5 volume percent concentration) such that the modified silicone comprised in the lubricating layer becomes 22.5 volume percent concentration.

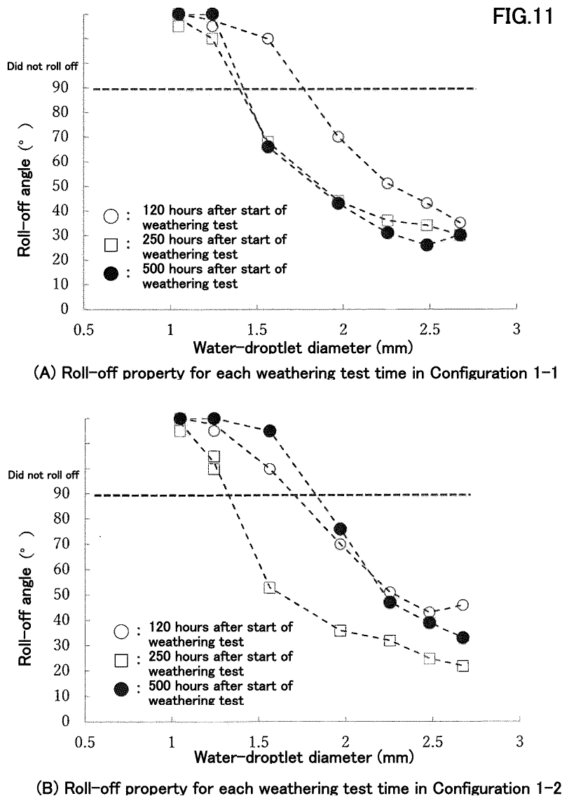

FIG. 11 (A) shows the measurement result of the weathering test of Configuration 1-1. FIG. 11 (B) shows the measurement result of the weathering test of Configuration 1-2. The water-sliding membranes of Configuration 1-1 and Configuration 1-2 maintain the roll-off property (up to after 500 hours of the weathering test) equivalent to Configuration 1.

### REFERENCE SIGNS LIST

10 Water-sliding membrane
12 Glass substrate
14 Base layer
14A Phenyl group
14B Vinyl group
16 Lubricating layer
40 Target liquid to be slid

1. A water-sliding membrane comprising:
a base layer formed on a substrate and a lubricating layer retained to the base layer, wherein
the base layer is formed by modifying a reactive functional group to a surface of the substrate,
the lubricating layer is configured of a polymer comprising a reactive functional group that can form a covalent bond with the reactive functional group of the base layer,
a portion of the reactive functional group of the base layer and a portion of the reactive functional group of the lubricating layer form the covalent bond,
the base layer comprises a cyclic conjugated functional group modified to the surface of the substrate,
the lubricating layer comprises a polymer comprising a hydrogen atom charged to δ⁺, and
a portion of the cyclic conjugated functional group of the base layer and a portion of the hydrogen atom charged to δ⁺ of the lubricating layer have π-electron interaction.

2. The water-sliding membrane of claim 1, wherein
the reactive functional group is at least one type of a functional group selected from a group consisting of a carbon-carbon double bond containing group, a carboxy group, an amino group, a hydroxy group, and an epoxy group.

3. The water-sliding membrane of claim 1, wherein
the base layer is a silicon oxide (SiOx) comprising the reactive functional group and the cyclic conjugated functional group.

4. The water-sliding membrane of claim 1, wherein
the lubricating layer is a modified silicone comprising the reactive functional group and the hydrogen atom charged to δ⁺.

5. The water-sliding membrane of claim 1, wherein
the reactive functional group of the base layer is at least one type of a functional group selected from a group consisting of a vinyl group, an acrylic group, a methacrylic group, a carboxy group, an amino group, a hydroxy group, and an epoxy group, and
the cyclic conjugated functional group of the base layer is a phenyl group.

6. The water-sliding membrane of claim 1, wherein
the reactive functional group of the lubricating layer is at least one type of a functional group selected from a group consisting of a carboxy group, a vinyl group, an acrylic group, a methacrylic group, an amino group, a hydroxy group and an epoxy group, and
the hydrogen atom charged to δ⁺ is a portion of at least one type of a functional group selected from a group consisting of a carboxy group, a phenol group and a hydroxy group.

7. The water-sliding membrane of claim 1, wherein a mass ratio of a component of the cyclic conjugated functional group of the base layer and a component of the reactive functional group of the base layer is 1:1 to 1:3.

8. An article having a surface coated with the water-sliding membrane of claim 1.
